(19) United States
(12) Patent Application Publication
(10) Pub. No.: US 2008/0114780 A1
(43) Pub. Date: May 15, 2008

(54) EFFICIENT DATABASE DATA TYPE FOR LARGE OBJECTS

(76) Inventors: Kwai Hing Man, Fremont, CA (US); Wai Kei So, Daly City, CA (US)

Correspondence Address: Kunzler and Associates, David J. McKenzie, 8 East Broadway, Suite 600, Salt Lake City, UT, 84111, US

(21) Appl. No.: 11/558,768

(22) Filed: Nov. 10, 2006

(51) Int. Cl. G06F 17/30

(52) U.S. Cl. 707/100; 707/E17.044

(57) ABSTRACT

A method and program product for storing large objects (LOBs) in a database is disclosed in one embodiment of the invention as including creating a column in a database. The column is created by assigning a data type to the column suitable for storing LOBs, assigning a maximum length for each LOB in the column, and assigning a length of an initial portion of each LOB. Once the column is created, one or more LOBs may be stored in the column. These LOBs are stored by storing the initial portions of each LOB substantially contiguously on certain pages of the database, while storing the remaining portions of each LOB on separate pages of the database. A pointer is provided with each initial portion. The pointer stores the location of the remaining portion of each LOB.

### BACKGROUND OF THE INVENTION

1. Field of the Invention

This invention relates to databases and more particularly to database data types for efficiency storing and retrieving large objects.

2. Description of the Related Art

Databases and other applications have been designed to handle various types of structured and unstructured of data. For example, many databases support the LOB (Large Object) data type as a way to handle large pieces of unstructured data, such as large blocks of text, graphic images, videos, sound files, or the like. The large size of LOBs, however, can dramatically hinder performance of databases and other applications when there is a need to retrieve and/or update this data. For example, a typical database page of 4 kB can hold only four rows where each row contains a 1 kB LOB. A large number of disk I/Os may be needed to perform reads or writes to rows of this size, thereby incurring substantial performance costs.

Nevertheless, it is often unnecessary to know all of the information represented in a LOB. A user is often only interested in information stored at the beginning of a LOB. For example, in the case of a CLOB (Character Large Object) used to store a chapter of a book, a user may only be interested in retrieving the beginning of the chapter to identify the topic and subject matter of the entire chapter.

This principle also holds true for LOBs storing other types of data as well. For example, a book may typically include a table of contents at the beginning of the book. A PowerPoint presentation may include an initial slide giving the title and description of the presentation. Insurance claim forms often list the most relevant information about a customer at or near the beginning of the document. An initial sound clip is often sufficient to identify an audio recording such as a song or voice recording.

With some databases, a “substring” function may be used to retrieve a specified portion of an object. However, this function may impose a runtime cost on every single row during data retrieval. This can have substantial performance costs with LOBs because it may require loading the entire LOB column into memory. For example, a computer that has 1 MB of memory can store at most 1 kB rows where each contains a 1 kB LOB. The “substring” function may then be used to extract, for example, 256 bytes from each LOB, but only after incurring substantial performance costs.

In view of the foregoing, what is needed is an apparatus and method for retrieving a specified portion of a LOB without having to load the entire LOB into memory. Ideally, such an apparatus and method would greatly reduce the number of I/Os needed to perform reads or writes of LOBs in a database, resulting in significantly improved performance.

### SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide an improved method and program product for storing large objects (LOBs) in a database.

In one aspect of the invention, a method for storing LOBs in a database includes creating a column in a database. The column is created by assigning a data type to the column suitable for storing LOBs, assigning a maximum length for each LOB in the column, and assigning a length of an initial portion of each LOB. Once the column is created, one or more LOBs may be stored in rows of the column. These LOBs are stored by storing the initial portions of each LOB substantially contiguously on certain pages of the database, while storing the remaining portions of each LOB on separate pages of the database. A pointer is provided with each initial portion to store the location of the remaining portion.

In another aspect of the invention, a program product for storing LOBs in a database includes a computer readable medium storing a computer-readable program for execution on a computer. When executed, the program product causes the computer to create a column in a database, assign a data type to the column suitable for storing LOBs, assign a maximum length for each LOB in the column, and assign a length of an initial portion of each LOB. The program product further causes the computer to store one or more LOBs in the column by storing the initial portions of each LOB substantially contiguously on certain pages of the database, while storing remaining portions of each LOB on separate pages of the database. The program product further causes the computer to store, with the initial portions, pointers storing the locations of the remaining portions.

The present invention provides a novel method and program product for storing and retrieving LOBs that reduces the number of I/Os needed to perform reads or writes to rows in a database, resulting in significantly improved performance. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a prior art example of a conventional technique for storing LOBs in pages of database tables; and

FIG. 2 is an example of a more efficient method for storing LOBs in pages of database tables.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of apparatus and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

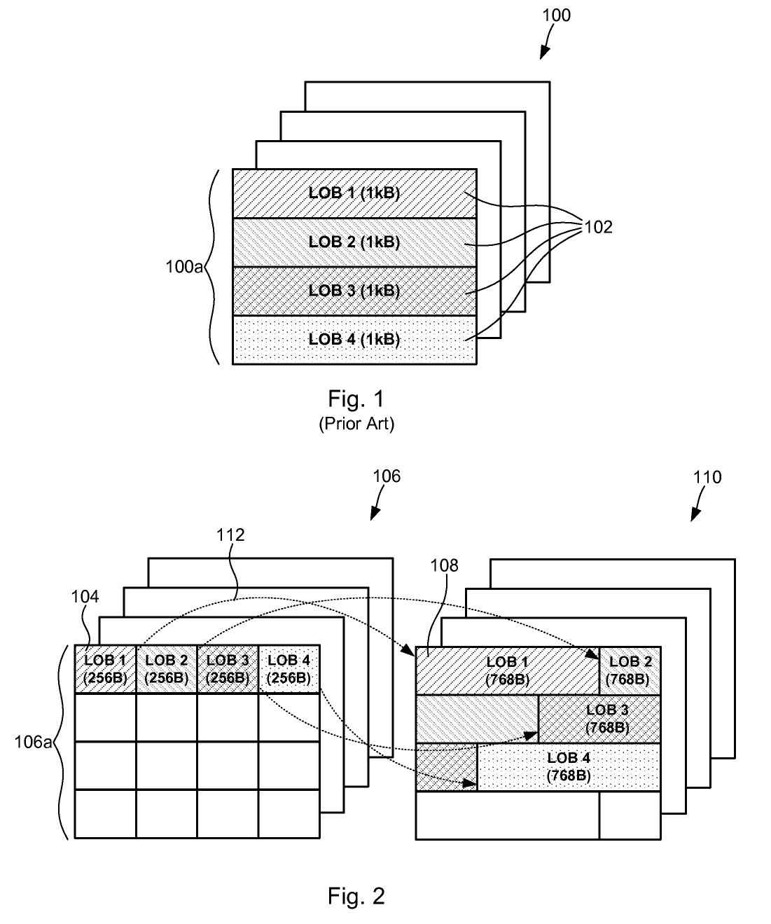

Referring to FIG. 1, as previously mentioned, many databases support the LOB (Large Object) data type as a way to handle large pieces of unstructured data, such as text, graphic images, videos, sound files, or the like. In practice, a column of type LOB may be conceptually part of a base database table, but may be physically stored in a separate table (i.e., auxiliary table) residing in a separate LOB tablespace. As previously mentioned, LOBs can dramatically degrade the performance of databases and other applications that retrieve and update this type of data.

In general, database tables may be stored in one more pages 100 stored on a hard disk or other mass storage device. As data is added to a table, pages 100 may be added to accommodate the additional data. In certain cases, a database may utilize a default page size, such as 4kB, to store data. This page size may be adjusted where a database is used to store large objects or the database's tables are very large. Although increasing the page size may improve database performance by decreasing I/O time (i.e., by reducing the number of pages retrieved) large database pages 100 also require more memory, creating a tradeoff.

For example, where 1 kB LOBs are stored in rows of a database, a typical 4kB database page 100a can hold only four rows 102. This configuration requires a large number of disk I/Os to and from the storage device when retrieving or updating LOBs stored in this manner, incurring substantial performance costs. Furthermore, this configuration is also inefficient because the entire LOB must normally be loaded into memory when it is retrieved or updated.

Referring to FIG. 2, in selected embodiments in accordance with the invention, a new data type may be implemented to significantly reduce the time needed to access LOBs stored in a database. The present invention capitalizes on the fact that LOBs are typically referenced in a read operation and then only a relatively small portion is required to satisfy most queries for LOBs. For the purposes of this description, this new data type may be referred to as a Variable LOB, or VLOB, to aid in understanding the invention. Nevertheless, the data type is not limited to any particular name but may take on a wide variety of names or labels without departing from the principals of operation and characteristics of the data type described herein.

In one embodiment, a user may be able to declare a column in a database table of type VLOB. This may be accomplished by entering VLOB (x, y), where x may represent the maximum length of the large object in bytes and y represents an initial portion of the large object in bytes. The database may then be configured to store the initial portion 104 (i.e., the first y bytes) of each large object substantially contiguously in the column on certain pages 106 of the database. The remaining portion 108 (i.e., x−y bytes) of each large object may then be stored on separate pages 110 of the database. In certain embodiments, the database may store with each initial portion 104 (e.g., at the y+1^{st} byte) a pointer 112 to the remaining portion 108 in the separate pages 110. A delimiter (e.g., at the y+2^{nd} byte) may also be included to separate the initial portions 104 from one another.

For example, as illustrated in FIG. 2, a user may assign a maximum length of 1 kB (i.e., 1024B) to each large object in a column. The user may also assign the length of each initial portion 104 at 256B, which represents about twenty-five percent of the total length of the large object. Thus, the database may store the initial portions 104 of each large object substantially contiguously in certain pages 106 of the database, while storing the remaining portions 108 (i.e., 768B) of each large object in separate pages 110 of the database. A pointer 112 (e.g., 1B) is provided with each initial portion 104, such as at or near the end of each initial portion 104, storing the location of the remaining portion 108 of each large object.

This configuration allows the initial portions 104 of approximately sixteen large objects to be stored on a single database page 106a as opposed to storing the entire length of four LOBs on a single page 100a as illustrated in FIG. 1. Accordingly, this may reduce the number of I/Os (i.e., number of pages accessed) by approximately a factor of four (or other factor depending on the value of x and y) when updating or retrieving only the initial portions 104 of LOBs. Because there may be many rows in a database, this technique may provide a significant performance improvement.

Although this technique may only retrieve an initial portion 104 of each LOB under normal circumstances, it relies on the principle that the initial portion 104 often provides sufficient information to inspect or sample a LOB. If desired, the rest 108 of the LOB can be retrieved at the location stored by the pointer 112.

For example, in certain embodiments, a database may be configured such that a regular SELECT function returns only the initial portion 104 of each LOB. A different function (e.g., SUPERSTRING(column, position, length)), on the other hand, may be used to retrieve information beyond the end of the first y bytes. For example, a call to SUPERSTRING(chapter, 0, ALL) may be used to retrieve an entire column's contents, thereby retrieving the entire content of an LOB stored in the column. Similarly, a call to SUPERSTRING(chapter, 250, 10) may be used to retrieve ten bytes starting from the 250^{th} byte. Again, the premise is that it is often unnecessary to see information beyond the first y bytes due to the ability of a user to infer significant information from the initial y bytes. Thus a SUPERSTRING function may be used infrequently but may be available if needed.

The present invention may be embodied in other specific forms without departing from its operating principles or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for storing large objects (lobs) in a relational database, the method: comprising:
creating a column in a relational database, wherein creating comprises:
assigning a data type to the column, the data type suitable for storing LOBs;
assigning a maximum length for each LOB in the column;
assigning a length of an initial portion of each LOB;
storing a plurality of LOBs in rows of the column, wherein storing comprises:
storing the initial portions of each LOB substantially contiguously on a first page of the database;
storing remaining portions of each LOB on one or more additional pages of the database; and
storing, with the initial portions, pointers storing the locations of the remaining portions of each LOB.

2. The method of claim 1, further comprising retrieving, in response to a first function, only the initial portion of one or more LOBs.

3. The method of claim 1, further comprising retrieving, in response to a second function, data beyond the initial portion of one or more LOBs.

4. A program product for storing LOBs in a database, the program product comprising a computer readable medium storing a computer-readable program that when executed on a computer causes the computer to:
create a column in a database;
assign a data type to the column, the data type suitable for storing LOBs;
assign a maximum length for each LOB in the column;
assign a length of an initial portion of each LOB;
store a plurality of LOBs in rows of the column;
store the initial portions of each LOB substantially contiguously on a first page of the database;
store remaining portions of each LOB on one or more additional pages of the database; and
store, with the initial portions, pointers storing the locations of the remaining portions of each LOB.

5. The program product of claim 4, further comprising retrieving, in response to a first function, only the initial portions of one or more LOBs.

6. The program product of claim 4, further comprising retrieving, in response to a second function, data beyond the initial portions of one or more LOBs.
